(19) United States
(12) Patent Application Publication
(10) Pub. No.: US 2019/0080537 A1
(43) Pub. Date: Mar. 14, 2019

(54) SYSTEM TO DETECT, TRACK, WARN, SHUT DOWN AND/OR LOCKOUT AN INDUSTRIAL VEHICLE ENTERING AN UNSAFE AREA

(71) Applicant: QUARION TECHNOLOGY INC, Newburgh, IN (US)

(72) Inventors: ARIC M. PRYOR, BOONVILLE, IN (US); MIKE CIHOLAS, EVANSVILLE, IN (US); JUSTIN BENNETT, NEWBURGH, IN (US); NATHANIEL KAMRATH, NEWBURGH, IN (US)

(73) Assignee: QUARION TECHNOLOGY INC, Newburgh, IN (US)

(21) Appl. No.: 15/702,901

(22) Filed: Sep. 13, 2017

(51) Int. Cl. G07C 9/00; G05D 1/00; B60R 25/10; B60R 25/00; B60R 25/04; B60R 25/22; H04W 4/02; G08B 7/06

(52) U.S. Cl. CPC G07C 9/00119; G05D 1/0055; B60R 25/10; B60R 25/002; H04W 4/046; B60R 25/225; H04W 4/021; G08B 7/06; B60R 25/04

(57) ABSTRACT

A system is provided for use in an industrial loading dock wherein the location of an industrial vehicle is detected and tracked in real-time, and one or more safety zones are created such that a computer or microcontroller triggers a response in the industrial vehicle upon the vehicle's entry into each such zone. The system includes a plurality of anchor radio transceivers positioned in proximity to a workspace. Each anchor radio transceiver is positioned in a known location such that the plurality of anchor radio transceivers form a fixed array of anchor radio transceivers. At least one mobile radio transceiver associated with a mobile industrial vehicle is also provided. The mobile radio transceiver is configured to exchange data packets of information with one or more of the plurality of anchor radio transceivers. A computer is provided that is in communication with the fixed array of radio transceivers. The computer is capable of determining the coordinate location of the mobile radio transceiver based on the received data packets of information. The computer is further capable of defining one or more safety zones at any location within the workspace such that a programmed action is taken when the mobile radio transceiver enters one of the one or more safety zones.

### BACKGROUND OF THE INVENTION

### Field of the Invention

The present invention relates to loading dock safety systems. More specifically, the present invention relates to a system for detecting and tracking the real-time position of an industrial vehicle, warning the vehicle operator when the vehicle approaches a dangerous area, and shutting down and/or locking out the vehicle if, or before it proceeds into the dangerous area.

### Description of the Related Art

According to OSHA, there are approximately 94, 750 (reported) forklift related injuries every year. Of that, 7% of these accidents occur when a forklift is driven off a loading dock. Additionally, lost productivity from workplace injuries cost US companies over $60 billion per year; while one fatality can ruin a family FOREVER and cost over $1 million to the company.

Current industry practices center on the use of dock lock mechanisms, dock monitoring systems, or other systems which will prevent the unintentional movement of trucks and trailers while being boarded by industrial vehicles such as forklift trucks. Such systems include chocks for the wheels of the trailer to prevent movement and/or hooks to ensure that the bumper of the trailer is locked in place at the loading dock. These systems assist in preventing the trailer from separating from the dock while an industrial vehicle is in the process of loading or unloading cargo from the trailer. These dock lock systems are often coupled with hazard recognition and communication systems to alert an operator of an industrial vehicle when a dock is in an unsafe condition. Such clear, concise communication is critical to safety at the loading dock. Light communication and alarms are currently employed to inform dock personnel when they can safely enter and exit a truck trailer and inform truck drivers when it is safe to depart.

However, distractions still exist, and, despite all of the lights, alarms and warnings, accidents still occur where an industrial vehicle attempts to enter an open or closed dock door where a trailer is either not present, or is not properly locked into the dock.

Accordingly, there is a need for a system that can actively track an industrial vehicle in the workspace, provide further warnings to the operator thereof, and, if necessary, automatically shut down and lock out the industrial vehicle if it comes to close to an unsafe open dock door.

### SUMMARY OF THE INVENTION

It is therefore an object of the present invention to provide a system to detect and track the position location of an industrial vehicle within a workspace and to provide one or more safety zones defined by data that trigger an automated responsive action from the industrial vehicle.

It is also an object of the invention to provide a system that will prevent an industrial vehicle such as a forklift truck from entering an unsafe area around a dock door such that the operator of the vehicle is warned visually and audibly when the vehicle enters a first warning zone, the vehicle is temporarily disabled when it enters a second shut-down zone, and the vehicle is locked-out upon entering a third lock-out zone.

The present invention meets these objects by providing a system for use in an industrial loading dock wherein the location of an industrial vehicle is detected and tracked in real-time, and one or more safety zones are created such that a computer or microcontroller triggers a response in the industrial vehicle upon the vehicle's entry into each such zone.

According to one presently preferred embodiment of the invention, there is provided a system to detect, track, warn, shut down and/or lockout an industrial vehicle entering an unsafe area. The system includes a plurality of anchor radio transceivers positioned in proximity to a workspace, Each anchor radio transceiver is positioned in a known location such that the plurality of anchor radio transceivers form a fixed array of anchor radio transceivers. At least one mobile radio transceiver associated with a mobile industrial vehicle is also provided. The mobile radio transceiver is configured to exchange data packets of information with one or more of the plurality of anchor radio transceivers. A computer is also provided that is in communication with the fixed array of radio transceivers. The computer is capable of determining the coordinate location of the mobile radio transceiver based on timing of the received data packets of information. The computer is further capable of defining one or more safety zones at any location within the workspace such that a programmed action is taken when the mobile radio transceiver enters one of the one or more safety zones. The workspace is a warehouse and the mobile industrial vehicle is a forklift truck according to one aspect of the present invention.

According to a further aspect of the invention, the safety zone extends a distance into the warehouse from a docking door located at a loading dock at an outer edge of the warehouse. The safety zone may be activated when the docking door is in an unsafe condition, such as when the docking door is open and a trailer is not backed up to and locked into the loading dock. The safety zone is deactivated when the docking door is open and a trailer is backed up to and locked into the loading dock.

Yet a further aspect of the invention provides that the one or more safety zones are defined by data input into the computer defining a corresponding one or more boundaries within the workspace based on the known locations of the plurality of anchor radio transceivers. The one or more safety zones may preferably comprise a first warning boundary zone, a second shutdown boundary zone, and a third lockout zone. According to one aspect, an audible and/or visual alert may be triggered when the mobile radio transceiver breaches the first warning boundary zone. A further aspect provides an audible and visual alert that is triggered and the disabling of the mobile industrial vehicle for a predetermined period of time when the mobile radio transceiver breaches the second shutdown boundary zone. Yet another aspect of the invention is the triggering of an audible and visual alert and a lock-out of the mobile industrial vehicle when the mobile radio transceiver breaches the third shutdown boundary zone. A further aspect of the invention is the inclusion of an override system which permits a supervisor to either avoid vehicle lock-out or reset the vehicle to operating mode after it has been locked-out. The override system may include a key which can be inserted into a key opening on the forklift truck. Alternatively, the override system may further include a signal which can be transmitted to the forklift truck by a supervisor to unlock the vehicle.

Another aspect of the present invention is the providing of a means to determine the orientation of the forklift truck. This may be done by a first mobile radio transceiver located on the chassis or a carriage assembly portion of the forklift truck and a second mobile radio transceiver located in a different location on the chassis of the forklift truck.

In a further aspect of the invention, the computer is capable of determining the elevation of the first mobile radio transceiver that is located on the carriage assembly portion of the forklift truck.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a top plan view of a warehouse with loading dock doors and safety warning systems according to the prior art.

FIG. 2A is a top plan view of the warning, shutdown and lockout system for a forklift truck according to a preferred embodiment of the present invention showing the forklift truck entering a first warning boundary zone.

FIG. 2B is a top plan view of the warning, shutdown and lockout system for a forklift truck according to a preferred embodiment of the present invention showing the forklift truck entering a second shutdown boundary zone.

FIG. 2C is a top plan view of the warning, shutdown and lockout system for a forklift truck according to a preferred embodiment of the present invention showing the forklift truck entering a third lockout boundary zone.

FIG. 3 is a schematic representation of the exchanges of data packets between the mobile radio transceiver, first anchor radio transceiver and second anchor radio transceiver of the system shown in FIGS. 2A, 2B and 2C.

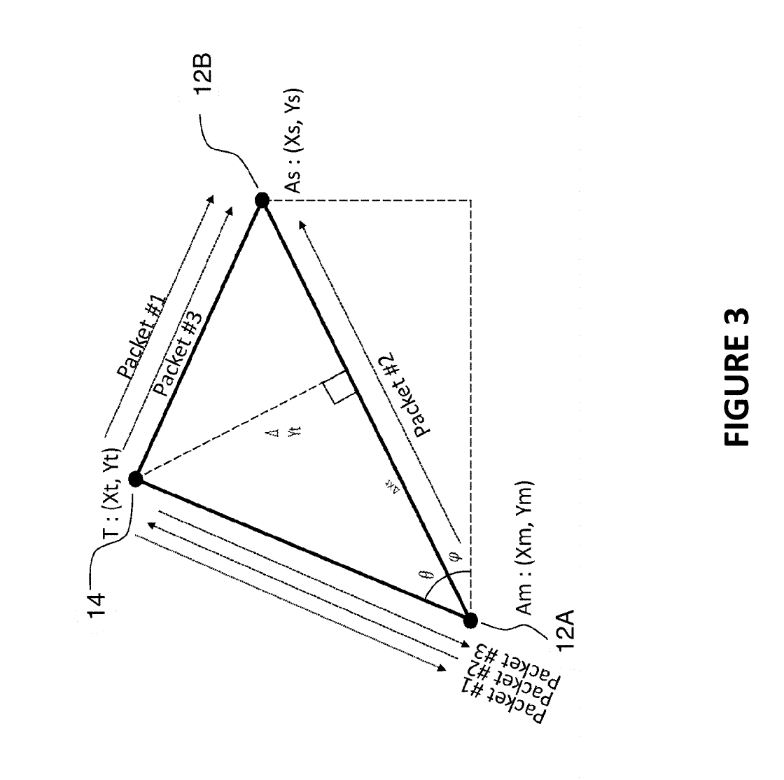

FIG. 4 is a notional time delay representation of three RF packets exchanged between two devices such as the first anchor radio transceiver and mobile radio transceiver shown in FIGS. 2A, 2B, 2C.

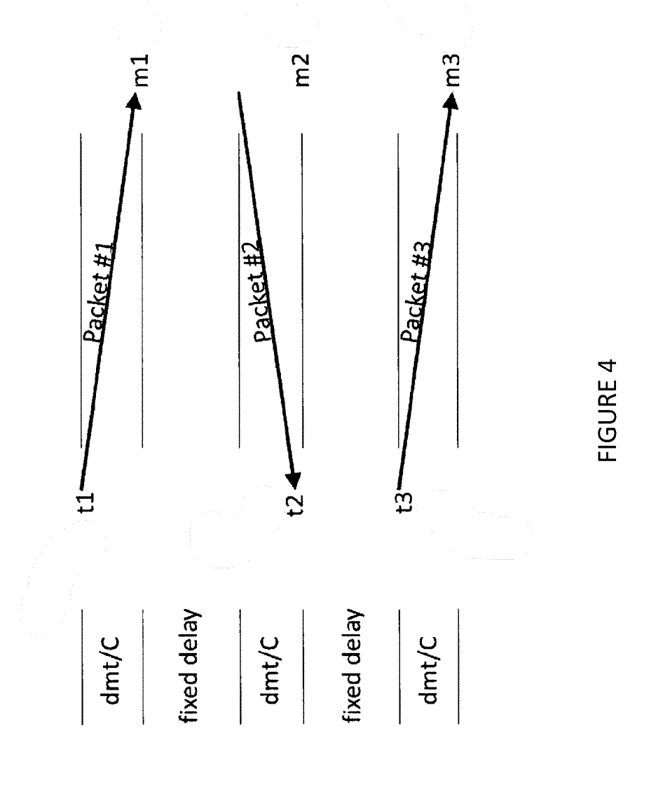

FIG. 5 is a perspective view of a forklift truck having first and second mobile radio transceivers mounted thereon according to an alternative preferred embodiment of the present invention.

FIG. 6 is a 3D pyramid depicting the distances associated with a system used to obtain 3D position coordinates of the first mobile radio transceiver shown in FIG. 4.

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

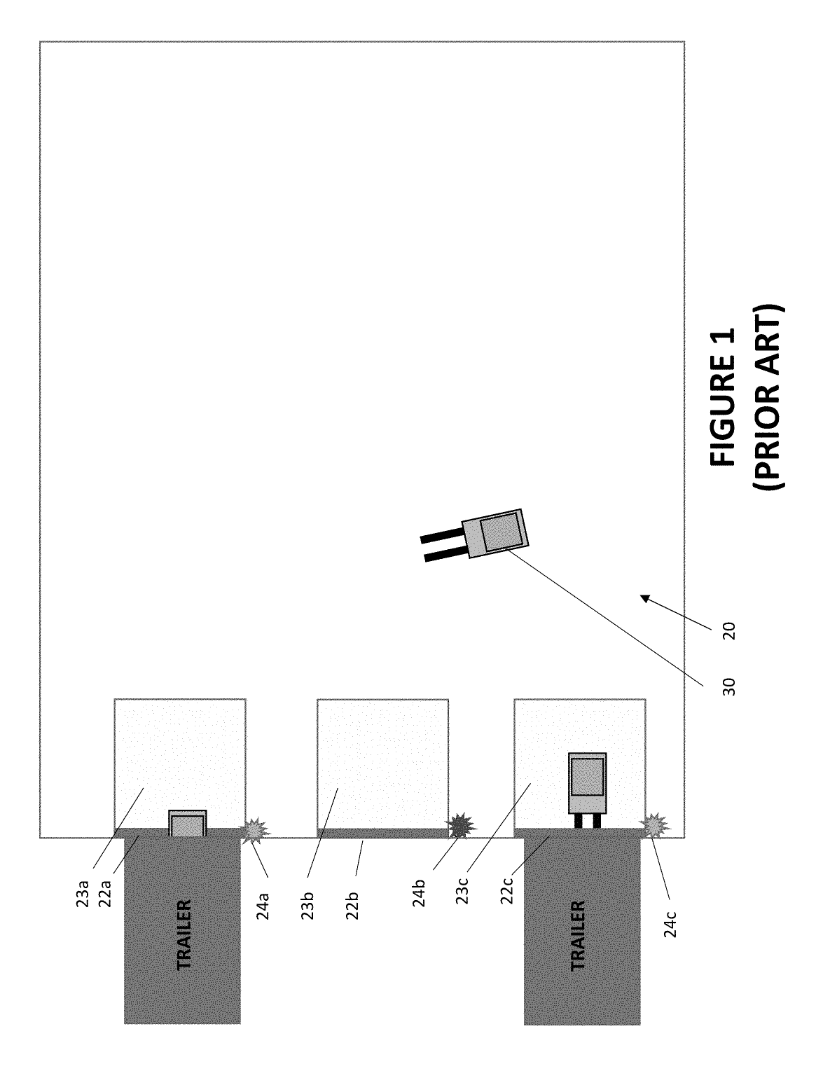

As best shown in FIG. 1, the system of the present invention is configured for use in a workspace, such as a warehouse 20. The warehouse 20 may include a plurality of dock doors 22a, 22b, 22c wherein a trailer can back up to a dock door to be loaded and/or unloaded. Dock levelers 23a, 23b, 23c may be provided in front of each dock door 22a, 22b, 22c to ensure a smooth path from the floor of the warehouse to the floor of the trailer. Under normal circumstances, trailer restraints, or dock locks (not shown), are used to secure the trailer to the dock to prevent accidents due to trailer-dock separation during loading. Lighted warning systems 24a, 24b, 24c are commonly used in connection with the dock locks in order to communicate to a driver of a forklift truck 30 that the trailer is properly locked onto the dock and that it is safe to enter the trailer for loading or unloading. The lighted warning systems 24a, 24c associated with dock doors 22a, 22c preferably display a green light to indicate that a trailer is present and properly locked into to loading dock, and a red light when the dock is not ready. The color of the lights or their operation, configuration or sequence serve to warn the forklift truck operator of a hazardous condition. As red and green are common colors used to control traffic, they are natural choices. However, other colors and features, such as flashing lights, can be used to provide notice to the forklift truck operator as to the status of the dock doors without departing from the spirit and scope of the invention.

However, even with these safeguards, accidents still occur where an inattentive forklift truck operator disregards the warnings and drives through a dock door that does not have a trailer locked into it, or does not have a trailer properly locked in to the dock, thereby causing an accident resulting in damage to the forklift truck, the trailer, the dock and/or injury to the forklift operator or other personnel. If, for example, as shown in FIG. 1, a loading dock door 22b is open and a trailer is not present or is not properly locked to the dock, even though the lighted warning system 24b associated with that door 22b is displaying a red warning light, it is still possible for a forklift truck operator to drive through the open door 22b resulting in damage and/or injury.

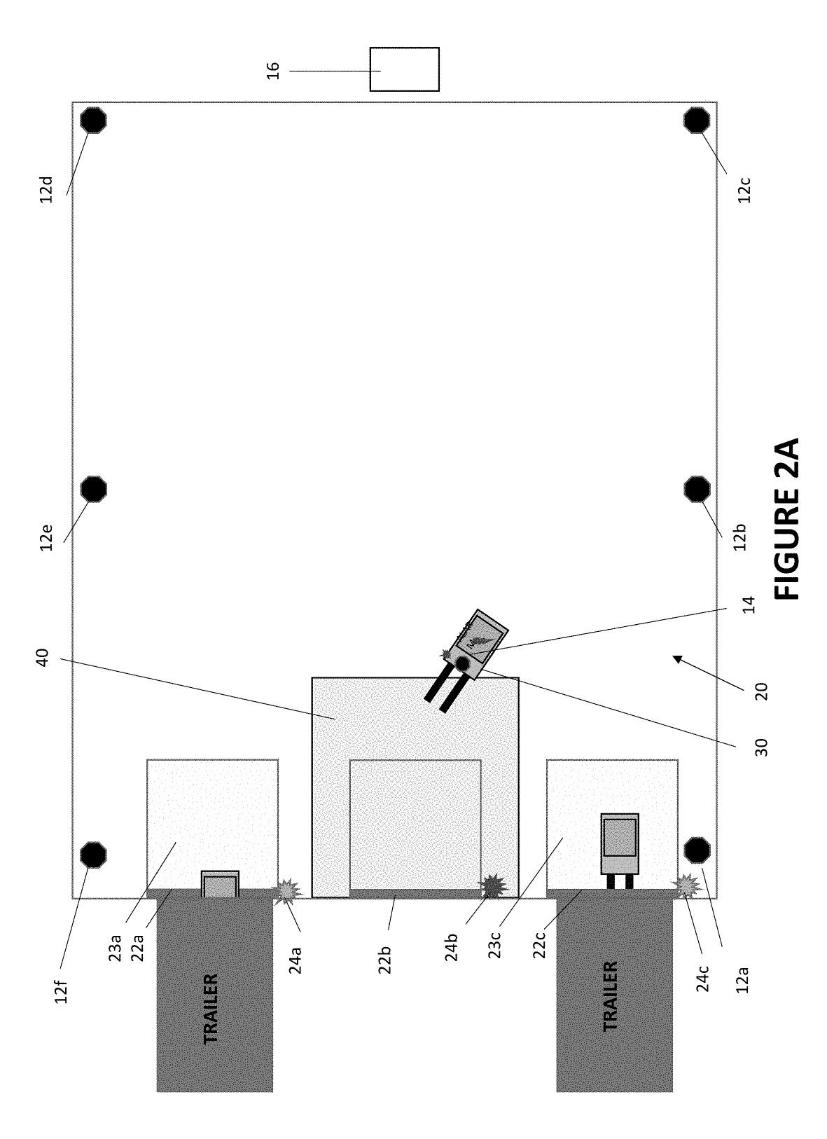

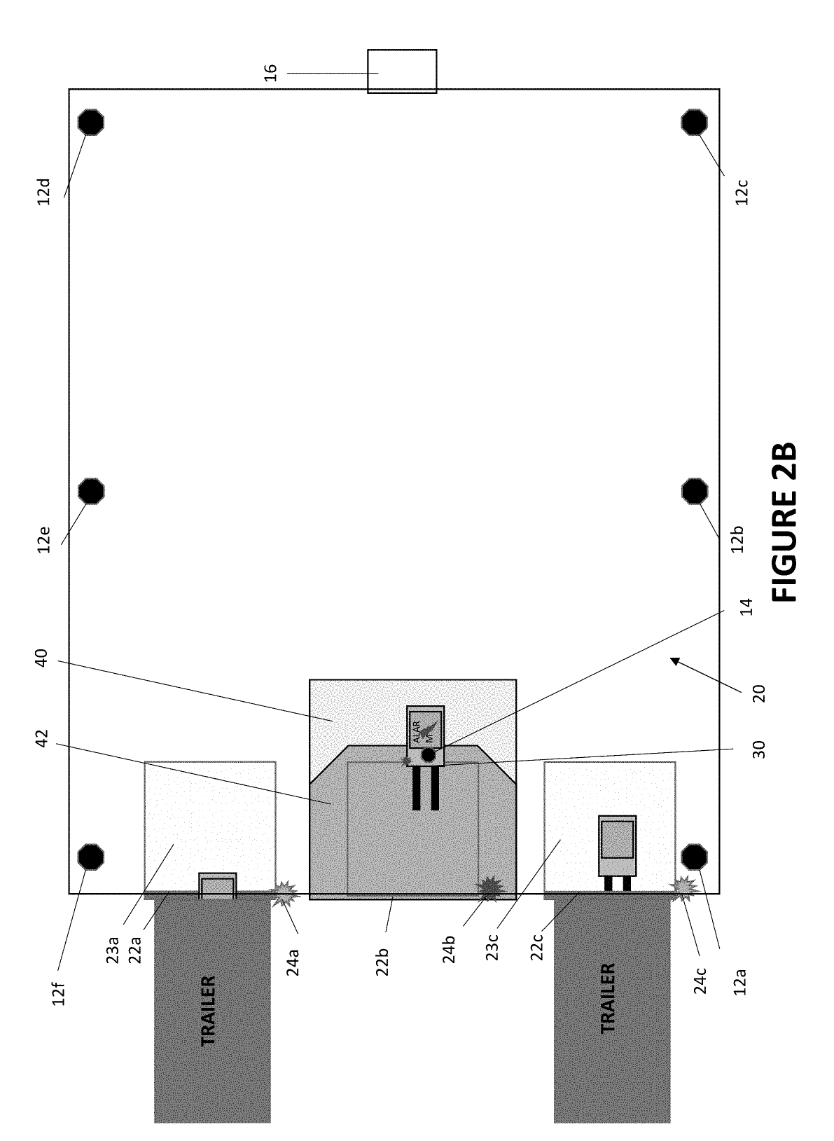

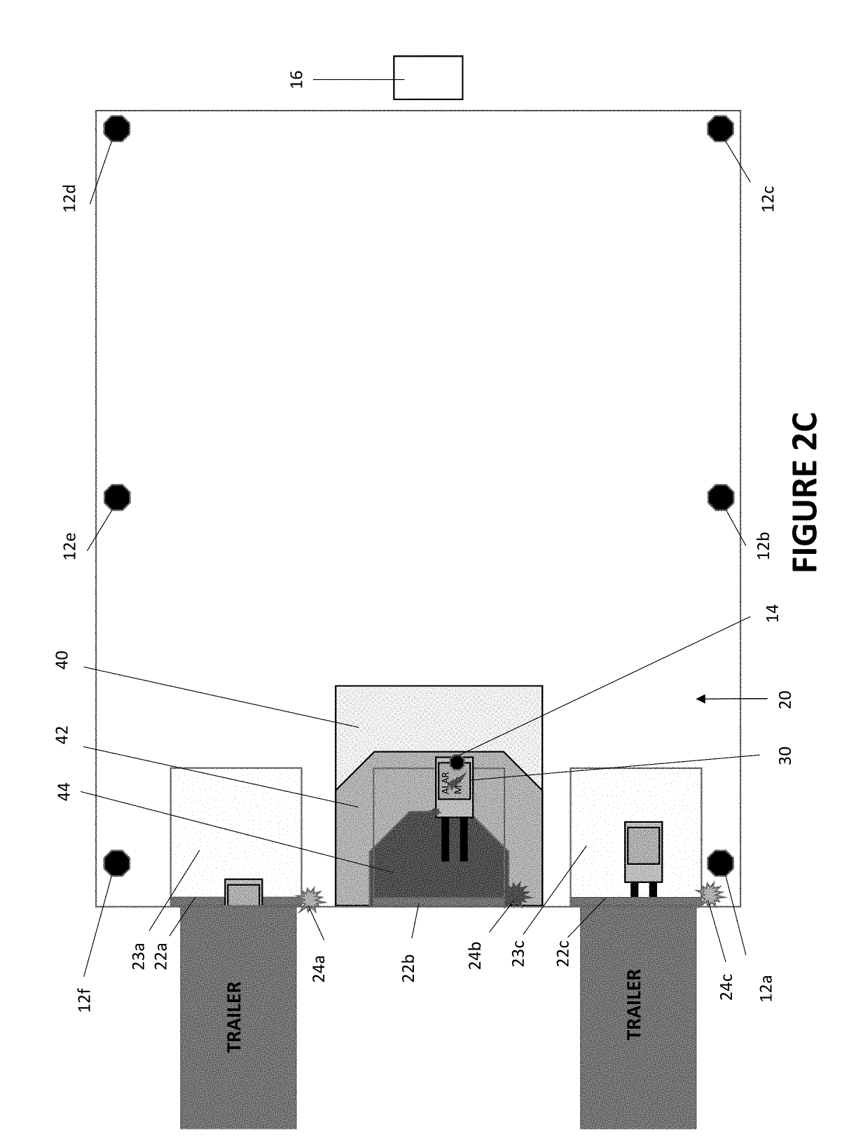

As best shown in FIGS. 2A-2C, one presently preferred embodiment of the invention comprises a system to detect, track, warn, shut down and/or lockout an industrial vehicle entering an unsafe area. The system according to this presently preferred embodiment includes a plurality of anchor ultrawideband (UWB) radio transceivers 12a, 12b, 12c, 12d, 12e, 12f positioned in or near the workspace or warehouse 20. Each of the anchor radio transceivers 12a, 12b, 12c, 12d, 12e, 12f is positioned in a known location such that the plurality of anchor radio transceivers form a fixed array of anchor radio transceivers. While six anchor radio transceivers are shown in FIGS. 2A-2C, depending on the algorithm in use for the location, only two or more anchor receivers are required for the system to operate. For example, where two way ranging plus snoop (TWR+S), as described in U.S. Pat. No. 9,709,663, or Multiple Two Way Ranging (MTWR) is used, as few as two anchors may be used to track the mobile transceiver 16 in two dimensions, whereas if Time Difference of Arrival (TDOA) is used, a minimum of four anchors are required. The more anchors that are provided, the better positional accuracy that will be realized on locating the position coordinates of the mobile radio transceiver 14. While the preferred embodiment of the present invention describes the use of UWB radio transceivers, any location system with adequate accuracy (e.g. automotive style radar, chirp spread spectrum radios, or RSSI based systems) could be used within the spirit and scope of the invention.

At least one mobile UWB radio transceiver 14 is associated with a mobile industrial vehicle, such as a forklift truck 30. The mobile radio transceiver 16 is configured to exchange data packets of information with one or more of the plurality of anchor radio transceivers 12a, 12b, 12c, 12d, 12e, 12f in order to determine the coordinate position of the mobile radio transceiver 14 and the forklift truck 30.

A variety of ultra wide band (UWB) algorithms, such as VML, TDOA, MTWR or TWR+S can be used to determine the position of the mobile radio transceiver 14. One example of a process for determining the coordinate position of the mobile radio transceiver 14 is disclosed in U.S. Pat. No. 9,709,662, the subject matter of which is incorporated herein by reference.

The micro controller 16 is also capable of defining one or more safety zones at any location within the workspace such that a programmed action is taken when the mobile radio transceiver 14 enters one of the one or more safety zones. In the preferred embodiment of the present invention, the one or more safety zones correspond to and extend inwardly from the dock doors 22a, 22b, 22c to warn and/or prevent a forklift truck 30 from going through a dock door when there is no trailer present and locked. As shown in FIG. 2A, when sensors detect that a trailer is present and locked at a dock door (i.e. dock doors 22a, 22c), the safety zones are deactivated so that forklift trucks can enter the trailer at each dock door. However, when sensors detect that a trailer is not present and locked into the dock as is shown at dock door 22b, a first warning boundary zone 40 is created and extends into the warehouse in the area around the dock door 22b. When the mobile radio transceiver 16 carried on the forklift truck 30 breaches the first warning boundary zone 40, a visual and audible alert is triggered in the forklift truck 30 to warn the driver he/she is entering an unsafe area. As shown in FIG. 2B, if the forklift truck driver ignores this alert and proceeds to drive the forklift truck that carries the mobile radio transceiver 14 into the second shutdown boundary zone 42, another audible and visual alert is triggered and the forklift truck 30 is disabled for a predetermined period of time, preferably 5 seconds, to allow the forklift truck driver to re-evaluate his/her course. In addition, when the mobile radio transceiver 14 enters the second shutdown boundary zone 42, the micro controller 16 may also generate a message via email or text to alert management. Finally, as shown in FIG. 2C, if the forklift driver continues toward the unsafe open dock door 22b and enters a third lockout zone 44, an audible and visual alert is triggered and the forklift truck 30 is locked-out and prevented from further movement. When the lockout zone 44 is breached, a further message is sent to management and a key is required to unlock the forklift truck 30 and allow it to resume operation. This may be accomplished by a physical key that a supervisor has to insert into a keyhole on the forklift truck 30, or it may take the form of an electronic signal that can be transmitted to the forklift truck 30 by a supervisor after a determination is made that no danger exists. Alternatively, the forklift truck may be unlocked when the zone becomes clear, perhaps when the operator gets off the forklift truck and activates the dock lock system properly locking the trailer to the dock. The warning boundary zone 40, shutdown boundary zone 42, lockout boundary zone 44, and any other zone the user may choose to create are defined by data input into the microcontroller 16 defining the specific shape and boundaries within the workspace based on the known locations of the plurality of anchor radio transceivers.

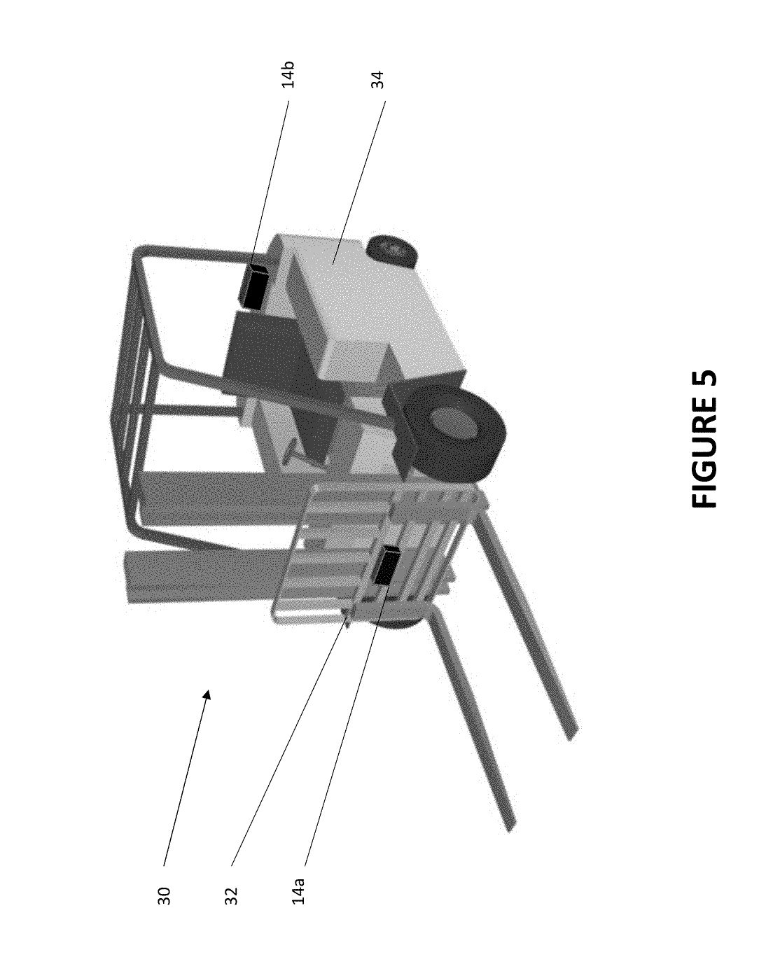

As shown in FIG. 5, a first mobile radio transceiver 14a may be positioned at any location on the forward portion of the forklift truck 30. According to a preferred aspect of the invention that would allow the position to be determined in the z axis as well, the first mobile radio transceiver 14a is positioned. on the carriage assembly 32 of the forklift truck 30. A second mobile radio transceiver 14b may be positioned somewhere on the forklift truck chassis 34 near the rear of the forklift truck 30 to allow the orientation and heading of the forklift truck 30 to be determined by the computer 16. Knowing that the first mobile radio transceiver 14a is positioned near the front of the forklift truck 30 and the second mobile radio transceiver 14b is positioned near the rear of the forklift truck, when the positions of each of the first and second mobile radio transceivers 14a, 14b are determined as discussed above, the orientation and direction of the forklift truck can be determined. In addition, because the carriage assembly 32 may be used to raise or lower the forks 36 and the cargo, the micro controller 16 may further compute the elevation of the first mobile radio transceiver 14a. This may be useful in other areas of the warehouse 20 such as doorways or where there are low hanging lights to set boundaries in the z-axis to ensure that if the forklift truck is traveling with the carriage assembly raised that the carriage assembly or the cargo do do accidentally come into contact with such hazards.

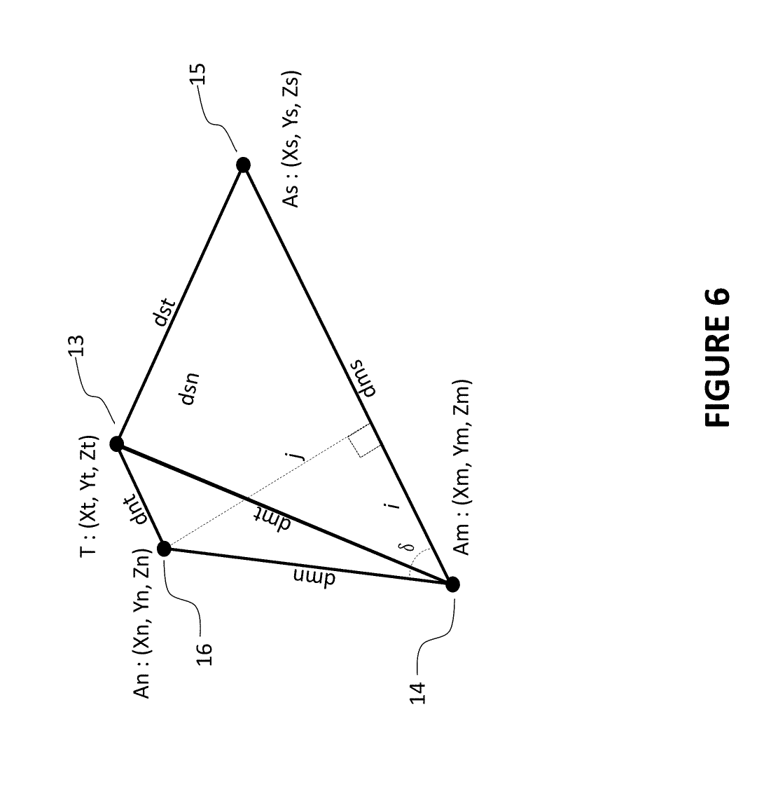

Yet another implementation includes the use of at least three of the anchor radio transceivers 12A, 12B, 12C in order to achieve a 3D position of the mobile radio transceiver 14 with respect to the anchors. The arrangement in FIG. 6 shows an exemplary arrangement of a plurality of anchors allowing for 3D position determination of the mobile radio transceiver 14. In the arrangement shown in FIG. 6, there is a mobile radio transceiver 14 at an unknown location and multiple anchor radio transceivers 12A, 12B, 12C at known, or surveyed, locations.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

We claim:

1. A system to detect, track, warn, shut down and/or lockout an industrial vehicle entering an unsafe area comprising:
a plurality of anchor radio transceivers positioned in proximity to a workspace, each of said anchor radio transceivers being positioned in a known location such that the plurality of anchor radio transceivers form a fixed array of anchor radio transceivers;
at least one mobile radio transceiver associated with a mobile industrial vehicle, said mobile radio transceiver configured to exchange data packets of information with one or more of said plurality of anchor radio transceivers;
a computer in communication with said fixed array of radio transceivers, said computer capable of determining the coordinate location of the mobile radio transceiver based on the timing of the received data packets of information;
said computer being further capable of defining one or more safety zones at any location within the workspace such that a programmed action is taken when said mobile radio transceiver enters one of said one or more safety zones.

2. The system according to claim 1 wherein the workspace is a warehouse and said mobile industrial vehicle is a forklift truck.

3. The system according to claim 2 wherein the safety zone extends a distance into the warehouse from a docking door located at a loading dock at an outer edge of the warehouse.

4. The system according to claim 3 wherein the safety zone is activated when the docking door is in an unsafe condition.

5. The system according to claim 4 wherein the safety zone is activated when a trailer is not backed up to and locked into the loading dock.

6. The system according to claim 4 wherein the safety zone is deactivated when the docking door is open and a trailer is backed up to and locked into the loading dock.

7. The system according to claim 1 wherein said one or more safety zones are defined by data input into said computer defining a corresponding one or more boundaries within the workspace based on the known locations of the plurality of anchor radio transceivers.

8. The system according to claim 7 wherein said one or more safety zones comprise a first boundary zone, a second boundary zone, and a third boundary zone.

9. The system according to claim 8 wherein an audible and visual alert is triggered when the mobile radio transceiver breaches the first boundary zone.

10. The system according to claim 8 wherein an audible and visual alert is triggered and the mobile industrial vehicle is disabled for a predetermined period of time when the mobile radio transceiver breaches the second boundary zone.

11. The system according to claim 8 wherein an audible and visual alert is triggered and the mobile industrial vehicle is locked-out when the mobile radio transceiver breaches the third boundary zone.

12. The system according to claim 11 further comprising an override system which permits a supervisor to either avoid vehicle lock-out or reset vehicle to operating mode after it has been locked-out.

13. The system according to claim 12 wherein the override system includes a key which can be inserted into a key opening on the forklift truck.

14. The system according to claim 12 wherein the override system further includes a signal which can be transmitted to the forklift truck by a supervisor to unlock the vehicle.

15. The system according to claim 2 further comprising means to determine the orientation and heading of the forklift truck.

16. The system according to claim 2 wherein said at least one mobile radio transceiver includes a first mobile radio transceiver located on a carriage assembly portion of the forklift truck and a second mobile radio transceiver is located on the chassis of the forklift truck.

17. The system according to claim 16 wherein the computer is capable of determining the elevation of the first mobile radio transceiver.

18. The system according to claim 1 wherein the plurality of anchor radio transceivers and the mobile radio transceiver transmit and receive ultra-wideband signals.
